(19) United States
(12) Patent Application Publication
(10) Pub. No.: US 2011/0162409 A1
(43) Pub. Date: Jul. 7, 2011

(54) Air conditioning system for vehicle

(75) Inventors: Yoshihiko Okumura, Kariya-city (JP); Yasuhiro Sekito, Obu-city (JP); Kazuhiro Miyazawa, Anjo-city (JP); Takayoshi Kawai, Hoi-gun (JP); Tatsuhiro Matsuki, Obu-city (JP)

(73) Assignee: DENSO CORPORATION, Kariya-city (JP)

(21) Appl. No.: 12/930,342

(22) Filed: Jan. 4, 2011

(30) Foreign Application Priority Data
Jan. 7, 2010 (JP) 2010-2343
Mar. 26, 2010 (JP) 2010-72528

(51) Int. Cl. F25B 1/00; F16K 11/20

(52) U.S. Cl. 62/498; 137/637

(57) ABSTRACT

A driving apparatus for an air conditioning system has a first and a second electrical actuators for driving air control doors, wherein the first and second actuators are accommodated in a common housing so that they are modularized to each other. The driving apparatus further has a third electrical actuator for driving another air control door, wherein the third actuator is provided at a position separated from the housing. Driving circuits for the first to third actuators are formed on a single IC chip or on a single electrical circuit board. The driving circuits formed on the IC chip or the electrical circuit board is accommodated in the housing for the first and second actuators.

### CROSS REFERENCE TO RELATED APPLICATION

This application is based on Japanese Patent Application No. 2010-002343 filed on Jan. 7, 2010, and No. 2010-072528 filed on Mar. 26, 2010, the disclosures of which are incorporated herein by reference.

### FIELD OF THE INVENTION

The present invention relates to an air conditioning system for a vehicle and a driving apparatus for the air conditioning system, wherein the driving apparatus includes an actuator device having a sensing portion for detecting a rotational position of a rotating member.

### BACKGROUND OF THE INVENTION

According to one of prior arts, for example, as disclosed in Japanese Patent Publication No. 2003-134720, a driving apparatus for a vehicle air conditioning system includes multiple actuators for controlling multiple switching doors which open and/or close multiple air passages, wherein multiple driving circuits are provided for the respective actuators.

According to another prior art, for example, as disclosed in Japanese Patent Publication No. 2002-052924, multiple actuators and driving circuits therefor are accommodated in one housing so as to modularize them and thereby to reduce cost for parts and components thereof.

In the case that all of the actuators are arranged at such portions close to each other, as explained for the above prior art (JP 2002-052924), it can be expected to reduce the cost as a result of such modularization.

However, in some of the cases, all of the actuators can not be arranged at the portions close to each other due to positions of multiple switching doors (air control doors) to be provided in a casing of an air conditioning apparatus. There may be another case in which one (or some) of the actuators should be preferably located at a position remote from the other actuators.

In the above situation, although it is possible to modularize those actuators which are arranged at portions close to each other, it is not possible to modularize all of the actuators including the actuator (s) located at the position remote from the other actuators. Therefore, there are actuators which can be modularized on one hand, but there are other actuators which can not be modularized to the first mentioned actuators.

It is, therefore, not possible to reduce the cost (which could be achieved by the modularization) for the actuators which are not modularized.

According to a further prior art, for example, as disclosed in Japanese Patent Publication No. 2004-166320, an actuator device has a sensing portion for detecting a rotational position of a rotating member. According to such a conventional actuator device, a rotational speed of a DC electric motor is reduced in multiple steps by multiple reduction gears (a first to a third reduction gears), so that a driven member (such as air control doors or switching doors of an air conditioning apparatus) is operated by such rotational force of the electric motor via a link device connected to an output shaft of the actuator device. According to the actuator device of the above JP 2004-166320, four reduction gears are combined to reduce the rotational speed in three steps.

The sensor portion of the above actuator device has a sensor through which a lower-side shaft of a third reduction gear is inserted, so that the sensor is rotated together with the shaft to detect a rotational angle of the third reduction gear. Although not shown in the above JP 2004-166320, a link device for operating a driven member is connected to an output shaft (an upper-side shaft) of the third reduction gear extending in an opposite direction of the lower-side shaft.

According to the above actuator device (JP 2004-166320), a necessary torque is obtained and a miniaturization of the reduction gears is achieved by the multiple reduction gears. However, a number of parts and components for the actuator device is inevitably increased. It is, therefore, difficult to make the structure thereof simpler. When the number of the reduction gears was simply decreased, a size of the gear may become larger so as to obtain a desired speed reduction ratio. Therefore, a size of the actuator device itself may become larger.

Furthermore, according to the above actuator device (JP 2004-166320), the output shaft of the third reduction gear and the link device may not be correctly interlocked depending on a coupling structure between them. When a displacement occurs between them, it may become difficult to accurately detect a position of the link device. In such a case, it may be difficult to accurately detect by the sensor a position of the driven member.

In a case that a sensor is directly attached to the link device in order to avoid the above problem, the accuracy for detecting the position of the driven member will be increased. In such a case, however, since the link device is generally provided at a location remote from the electric motor for driving the reduction gears, the electric motor (to which electric power supply is necessary) and the sensor (from which detection signal is obtained) are provided at a distance from each other. Accordingly, wiring work for the sensor may become complicated and it may increase a manufacturing cost.

### SUMMARY OF THE INVENTION

The present invention is made in view of the above problems. It is an object of the present invention to provide an air conditioning system for a vehicle and/or a driving apparatus for the air conditioning system, according to which cost reduction can be achieved even in a case that there are actuators modularized and other actuators not modularized.

It is a further object of the present invention to provide an actuator device, which is low in cost and which can be able to accurately detect a position of a driven member operated by the actuator device.

According to a feature of the present invention, for example, as defined in the appended claim 1, a driving apparatus for an air conditioning system has;

a first electrical actuator for controlling a first air control member and a second electrical actuator for controlling a second air control member, both of which are accommodated in a housing;

a third electrical actuator for controlling a third air control member and provided at a location separated from the housing; and

a drive control portion for electrically controlling operations of the first to third electrical actuators.

In the above driving apparatus, the drive control portion is accommodated in the housing and driving circuits of the drive control portion for the respective electrical actuators are formed in a single IC chip or formed on a single electrical circuit board.

Generally, in a case that multiple electronic circuits are put together and formed on a single IC chip, manufacturing cost can be reduced compared with a case in which the multiple electronic circuits are formed on multiple respective IC chips. In a similar manner, in a case that multiple electronic circuits are formed on a single electric circuit board, manufacturing cost can be reduced when compared with a case in which the multiple electronic circuits are formed on multiple respective electric circuit boards.

According to the above feature, not only the driving circuits for the first and second electrical actuators (which are modularized to each other) but also the driving circuit for the third electrical actuator (which is not modularized) are formed on the single IC chip or on the single electric circuit board. Therefore, compared with a case in which the driving circuits for the first to the third driving circuits are separately formed on the respective IC chips or on the respective electric circuit boards, it is possible according to the invention to manufacture the driving circuits at a lower cost, to thereby reduce the costs for the parts and components.

According to another feature of the present invention, for example, as defined in the appended claim 2, the driving apparatus further has;

a connector provided in the housing and electrically connected to the drive control portion, wherein the third electrical actuator is electrically connected to the drive control portion via the connector; and

an electronic control unit for outputting a control signal to the drive control portion, wherein the electronic control unit is electrically connected to the drive control portion.

According to the above feature, the connector for electrically connecting the drive control portion to the third electrical actuator is commonly used as the connector for electrically connecting the drive control portion to the electronic control unit. Accordingly, a number of the connectors can be reduced and manufacturing cost for the parts and components can be reduced.

According to a further feature of the present invention, for example, as defined in the appended claim 3, the driving apparatus is applied to an air conditioning apparatus for a vehicle. In the air conditioning apparatus, the first electrical actuator drives air mode switching doors for switching an air blowing duct from which air is blown into a passenger compartment of the vehicle, the second electrical actuator drives an air mixing door for controlling temperature of the air to be blown into the passenger compartment, and the third electrical actuator drives an intake air switching door for switching from outside air to inside air and vice versa.

According to a still further feature of the present invention, for example, as defined in the appended claim 4, an air conditioning system for a vehicle has:

a blower unit having a blower device for blowing air into a passenger compartment of the vehicle;

an intake air switching door provided in the blower unit for switching the blowing air from outside air to inside air and vice versa;

an A/C unit having an evaporator for cooling down the blowing air and a heater core for heating the blowing air;

an air mixing door provided in the A/C unit for controlling temperature of the blowing air to be blown into the passenger compartment; and

air mode switching doors provided in the A/C unit for switching an air blowing duct from which the blowing air is blown into the passenger compartment.

The air conditioning system further has; a first electrical actuator for driving the air mode switching doors; a second electrical actuator for driving the air mixing door; and a third electrical actuator for driving the intake air switching door.

In the above air conditioning system, the blower unit and the A/C unit are mounted in the vehicle in such a manner that the blower unit is arranged at a left-hand side or a right-hand side of the A/C unit with respect to a longitudinal direction of the vehicle,

the first and second electrical actuators are accommodated in a housing, which is attached to the A/C unit,

the third electrical actuator is attached to the blower unit,

a drive control portion for electrically controlling operations of the first to third electrical actuators is further provided, and

the drive control portion is accommodated in the housing and driving circuits of the drive control portion for the respective electrical actuators are formed in a single IC chip or formed on a single electrical circuit board.

In the air conditioning system, in which the blower unit is arranged at the left-hand side or the right-hand side of the A/C unit with respect to the longitudinal direction of the vehicle, the third electrical actuator for the intake air switching door may not be preferably modularized to the first and second electrical actuators for the air mode switching doors and the air mixing door, in order that the A/C unit is commonly used for the left-hand drive and the right-hand drive vehicles.

Therefore, when the first and second electrical actuators are modularized to each other, the cost-down effect by such modularization can be achieved. On the other hand, since the third electrical actuator is not modularized, the cost-down effect can not be expected for the third electrical actuator.

According to the present invention, however, since the driving circuits for the first and second electrical actuators (which are modularized to each other) and the driving circuit for the third electrical actuator (which is not modularized) are formed on the single IC chip or formed on the single electric circuit board, the manufacturing cost for the driving circuits can be made lower. Thus, the cost-down for the parts and components can be done.

According to a still further feature of the present invention, for example, as defined in the appended claim 7, an actuator device has;

an actuator casing;

an electric motor accommodated in the actuator casing;

a first rotational member connected to the electric motor for outputting a rotational force of the electric motor;

a second rotational member to be connected to a driven member, the second rotational member being engaged with the first rotational member so that the rotational force is reduced in speed;

a sensor for detecting a rotational position of the second rotational member;

a shaft portion provided at the second rotational member so that the shaft portion is integrally rotated with the second rotational member without any rotational displacement between the shaft portion and the second rotational member,

wherein the sensor is accommodated in the actuator casing and connected to the shaft portion so that the sensor is rotated together with the shaft portion.

When the shaft portion (the rotational angle thereof is detected) and the second rotational member are connected to each other by a simple fit-in structure for preventing a relative movement between them, dimensional tolerance may be inevitably generated between the shaft portion and a recessed portion of the second rotational member into which the shaft portion is inserted. As a result, a rotational displacement may occur between them due to the fit tolerance (the dimensional tolerance), when the second rotational member starts its rotation.

According to the present invention, however, the shaft portion is rotated together with the second rotational member without causing the rotational displacement. Therefore, the rotational angle of the shaft portion is identical to the rotational angle of the second rotational member. In other words, the rotational angle of the shaft portion detected by the sensor, which is rotated together with the shaft portion, is identical to the rotational angle of the second rotational member.

In addition, the sensor is accommodated in the same housing to the housing in which the electric motor is accommodated, so that the electric motor (for which the electrical power supply is necessary) and the sensor (from which the detection signal is outputted) are arranged at such portions close to each other. Therefore, a structure for wiring the power supply and transmission of the detected signal can be made simpler. As a result, the actuator device, which is low in cost and which can achieve a high accuracy for detecting the rotational position of the rotational member, can be realized.

According to a still further feature of the present invention, for example, as defined in the appended claim 8, the electric motor is arranged at a side portion of the second rotational member in an axial direction of the second rotational member, and located between the sensor and the first rotational member which is engaged with the second rotational member at an outer periphery of the second rotational member.

According to the above feature, the first rotational member is engaged with the second rotational member at the outer periphery of the second rotational member. Therefore, there exists a distance (a space) between the sensor located at the rotational center of the second rotational member and the first rotational member, wherein the distance almost corresponds to a radius of the second rotational member. When the electric motor is arranged at the axial side portion of the second rotational member and located in the above space between the sensor and the first rotational member, the space at the side portion of the second rotational member (which has a relatively large diameter) can be effectively used. Accordingly, the parts and components are located in the actuator casing so that a radial length of the second rotational member is effectively used in the inside of the actuator casing. It is, thereby, possible to suppress the width (the length) of the actuator casing in the axial direction of the second rotational member. The miniaturization of the actuator casing and thereby the miniaturization of the actuator device is realized.

According to a still further feature of the present invention, for example, as defined in the appended claim 9, the electric motor has power supply terminals, and the electric motor is accommodated in the actuator casing in such a manner that the power supply terminals are located on a side of the electric motor close to the sensor.

According to such feature, the wires for the electric motor and the sensor as well as the connector portion can be effectively arranged in the actuator casing in view of the cost and the space.

According to a still further feature of the present invention, for example, as defined in the appended claim 10, the actuator device has first wires for supplying electric power to the electric motor, second wires for supplying the electric power to the sensor and for receiving detected signals from the sensor, and a connector portion connected to the first and second wires, wherein the first and second wires and the connector portion are accommodated in the actuator casing. The electric motor is arranged at such a position in the actuator casing, that the power supply terminals are located at a portion which is closer to the connector portion than to the sensor.

According to the above feature, the electric motor and the connector portion can be arranged with each other in a most effective location, so that the wires between them can be made shorter.

According to a still further feature of the present invention, for example, as defined in the appended claim 11, the first rotational member and the second rotational member form a pair of reduction gear engaged with each other.

According to the above feature, the rotational speed of the electric motor is reduced and the rotational force is outputted to the driven member. Therefore, while the number of gears can be decreased, a high accuracy for detecting the rotational position of the rotational member is obtained. The actuator device having a high product performance can be realized.

According to a still further feature of the present invention, for example, as defined in the appended claim 12, the second rotational member has an output side gear portion or cam grooves for driving the driven member, wherein the output side gear portion or the cam grooves are rotated together with the shaft portion.

According to such a feature, a simple structure (such as, the output side gear portion or the cam grooves) is provided at the second rotational member for transmitting a driving power to the driven member. A number of parts and components can be reduced and the actuator device having a high productivity can be realized.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing an entire structure for an air conditioning apparatus for a vehicle according to a first embodiment of the present invention;

FIG. 2 is a schematic outline view showing an A/C inside unit of the first embodiment for a right-hand drive vehicle;

FIG. 3 is a schematic view showing a structure for respective actuators;

FIG. 4 is a schematic view showing a structure for respective actuators according to a first comparative example;

FIG. 5 is a schematic view showing another structure for respective actuators according to a second comparative example;

FIG. 6 is a schematic outline view showing the A/C inside unit for a left-hand drive vehicle;

FIG. 7 is a schematic view showing an A/C inside unit according to a third comparative example for the right-hand drive vehicle;

FIG. 8 is a schematic view showing an A/C inside unit according to the third comparative example for the left-hand drive vehicle;

FIG. 9 is a schematic view showing a structure of an actuator device according to a second embodiment of the present invention;

FIG. 10 is a schematic side view (a partly cross sectional view) for showing a coupling structure between a second reduction gear and a shaft portion to be connected to a sensor;

FIG. 11 is a schematic side view (a sectional view) showing another coupling structure between the second reduction gear and the shaft portion to be connected to the sensor; and

FIG. 12 is a schematic view showing a structure of an actuator device according to a third embodiment of the present invention.

### DETAILED DESCRIPTION OF THE PREFERRED EMBODIMENTS

### First Embodiment

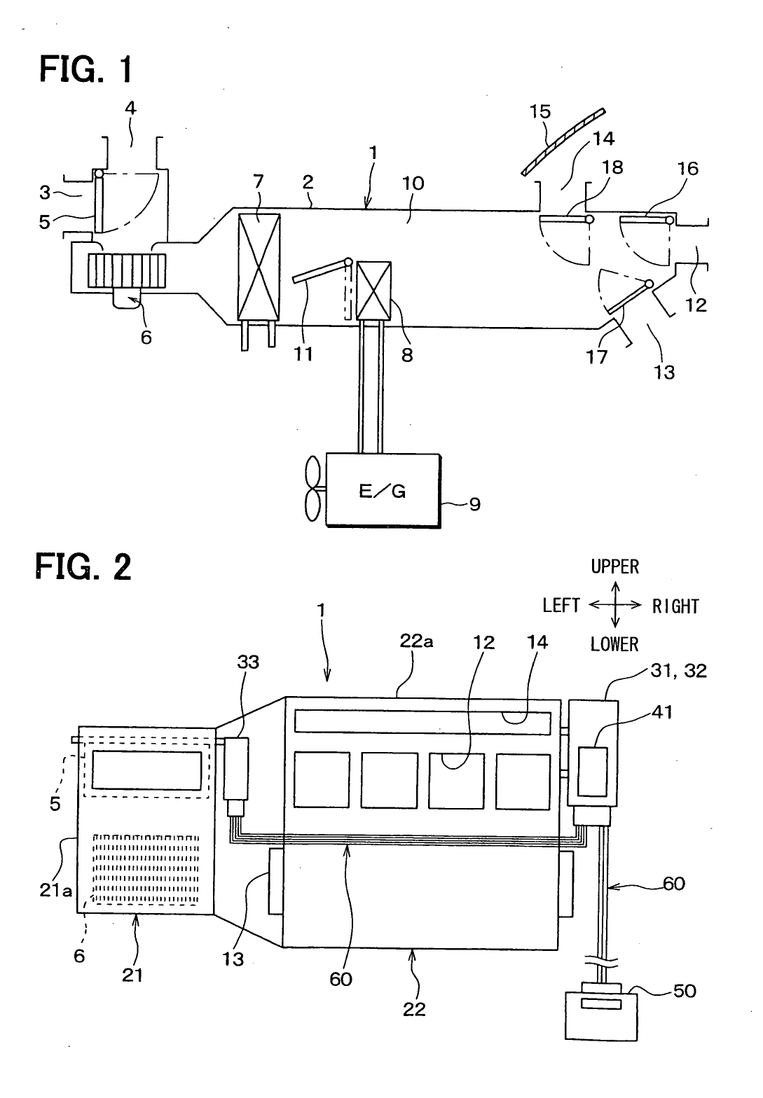

An entire structure for an air conditioning apparatus for a vehicle according to a first embodiment of the present invention is shown in FIG. 1.

The air conditioning apparatus for the vehicle has an A/C (air conditioning) inside unit 1, which is provided in an instrument panel. The A/C inside unit 1 has an A/C casing 2 for forming air passages through which air flows toward a passenger room of the vehicle.

At an upstream end of the A/C casing 2, an air intake port 3 for sucking inside air from the passenger room, another air intake port 4 for withdrawing outside air from the outside of the vehicle, and an intake air switching door 5 for switching from the inside air to the outside air (or vice versa) and for introducing such air into the air passage formed in the A/C casing 2, are respectively provided.

A blower device 6, an evaporator 7 and a heater core 8 are respectively arranged in this order, in the air passage at a downstream side of the intake air switching door 5.

The evaporator 7 is a heat exchanger for cooling down the intake air through heat exchange between refrigerant and the intake air. The evaporator 7 constitutes a refrigerating cycle together with a compressor (not shown), a condenser (not shown), a depressurizing device (not shown) and so on. The heater core 8 is a heat exchanger for heating the intake air passing through the evaporator 7 through heat exchange between engine cooling water for an engine 9 with the intake air.

A bypass air passage 10 is formed in the A/C casing 2 for bypassing the heater core 8. An air mixing door 11 is provided at an upstream side of the heater core 8. The air mixing door 11 adjusts a ratio of an amount of the air passing through the heater core 8 with respect to an amount of the air bypassing the heater core 8, so that temperature of air-conditioned air blown out into the passenger room is controlled.

At a downstream end of the A/C casing 2, the following air outlet ducts are provided:
a face duct 12 for blowing out the air-conditioned air toward an upper body of a passenger in the passenger room;
a foot duct 13 for blowing out the air-conditioned air toward passenger's feet in the passenger room; and
a defroster duct 14 for blowing out the air-conditioned air toward an inner surface of a front windshield 15.

Air mode switching doors 16, 17 and 18 are respectively provided in the A/C casing 2 at each upstream side of the above air outlet ducts 12, 13 and 14, in order to selectively open and/or close such air outlet ducts to thereby switch from one air blowing mode (for example, a face mode) to another air blowing mode (for example, a foot mode).

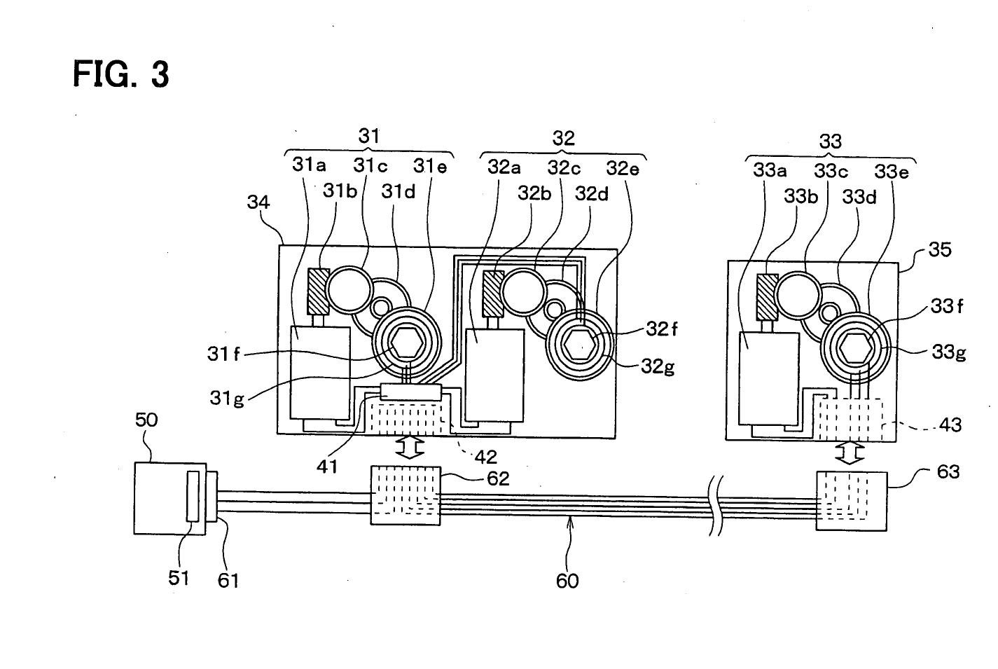

The air mode switching doors 16, 17 and 18 are operated by a first actuator 31 of an electric type (FIG. 3) by means of a link device (not shown). The air mixing door 11 is operated by a second actuator 32 of an electric type (FIG. 3), while the intake air switching door 5 is operated by a third actuator 33 of an electric type (FIG. 3). An operation for the first to third actuators 31, 32 and 33 is controlled by an electronic control unit (ECU) 50 for the air conditioning apparatus.

According to the present embodiment, the air mode switching doors 16, 17 and 18 correspond to a first air control member (also referred to as a first driven member), the air mixing door 11 corresponds to a second air control member (also referred to as a second driven member), and the intake air switching door 5 corresponds to a third air control member (also referred to as a third driven member). The first, second and third actuators 31, 32 and 33 correspond to driving units.

An outline view of an A/C unit casing 22a according to the first embodiment is schematically shown in FIG. 2. In FIG. 2, directions of right, left, upper and lower respectively show such corresponding direction when the A/C unit casing 22a is mounted to the vehicle, wherein a back of the drawing is a front side of the vehicle, while a front of the drawing is a back side of the vehicle.

The A/C inside unit 1 is a semi-center type unit for a right-hand drive vehicle, wherein a blower unit 21 is arranged at a left-hand side of an A/C unit 22 (that is, a left-hand side of the vehicle). The blower unit 21 includes the blower device 6 and the intake air switching door 5. The A/C unit 22 includes the evaporator 7 and the heater core 8 in the A/C unit casing 22a, in such a manner that the evaporator 7 and the heater core 8 are arranged in a vehicle longitudinal direction (although not shown in the drawing). The blower unit 21 is connected to the A/C unit 22, so that the A/C inside unit 1 is formed.

The first actuator 31 for the air mode switching doors and the second actuator 32 for the air mixing door are provided at a right-hand side of the A/C unit casing 22a.

The third actuator 33 for the intake air switching door 5 is provided at the left-hand side of the A/C unit casing 22a. As above, the third actuator 33 is provided at a position remote from the first and second actuators 31 and 32.

A schematic structure for the respective actuators 31, 32 and 33 is shown in FIG. 3, wherein the first actuator 31 for the air mode switching doors and the second actuator 32 for the air mixing door are accommodated in a common housing (a first housing) 34. Namely, the first and second actuators 31 and 32 are modularized to each other.

The first actuator 31 is composed of a first electric motor 31a and multiple gears 31b, 31c, 31d and 31e, which form a speed reduction mechanism. A first output shaft 31f and a first position sensor 31g are provided at the output-side gear 31e. The first output shaft 31f corresponds to a shaft for generating a driving power for operating the air mode switching doors 16, 17 and 18. The first position sensor 31g detects a rotational position of the first output shaft 31f and is composed of, for example, a potentiometer.

In a similar manner, the second actuator 32 is composed of a second electric motor 32a and multiple gears 32b, 32c, 32d and 32e, which form a speed reduction mechanism. A second output shaft 32f and a second position sensor 32g are provided at the output-side gear 32e. The second output shaft 32f generates a driving power for operating the air mixing door 11.

The third actuator 33 for the intake air switching door 5 is accommodated in a second housing 35, which is different from the first housing 34. Therefore, the third actuator 33 is not modularized together with the first and second actuators 31 and 32. In a similar manner to the first and second actuators 31 and 32, the third actuator 33 is composed of a third electric motor 33a and multiple gears 33b, 33c, 33d and 33e, which form a speed reduction mechanism. A third output shaft 33f and a third position sensor 33g are provided at the output-side gear 33e. The third output shaft 33f generates a driving power for operating the intake air switching door 5.

A drive control portion 41 is accommodated in the first housing 34, wherein the drive control portion 41 controls operations for the first to third electric motors 31a, 32a and 33a in accordance with control signals from the ECU 50. Detection signals of the first to third position sensors 31g, 32g and 33g are inputted to the drive control portion 41, and such signals are outputted from the drive control portion 41 to the ECU 50.

Although not shown in the drawing, the drive control portion 41 is composed of an electronic circuit board and semi-conductor chips (IC chips) mounted on the circuit board, wherein driving circuits for respectively supplying necessary driving power to the first to third electric motors 31a, 32a and 33a are formed in one of the IC chips. A communication circuit for carrying out communication with the ECU 50 is formed in the IC chip or on the circuit board. It is possible, by the communication circuit, to input the control signals from the ECU 50 and to output the detection signals from the position sensors 31g, 32g, 33g to the ECU 50.

The drive control portion 41 is electrically connected to the first and second electric motors 31a and 32a and to the first and second position sensors 31g and 32g via wires in the inside of the first housing 34.

Furthermore, the drive control portion 41 is electrically connected not only to the ECU 50 but to the third electric motor 33a and the third position sensor 33g of the third actuator 33, via a wire harness 60.

More exactly, a connector 42 is provided at the first housing 34, wherein the connector 42 has terminals which are electrically connected to the drive control portion 41. On the other hand, a connector 43 is provided at the second housing 35, wherein the connector 43 has terminals which are respectively connected to the third electric motor 33a and the third position sensor 33g.

The wire harness 60 has a connector 61 connected to the ECU 50, a connector 62 connected to the connector 42 of the first housing 34, and a connector 63 connected to the connector 43 of the second housing 35.

Therefore, when the connector 61 of the wire harness 60 is connected to a connector 51 of the ECU 50, while the connector 62 of the wire harness 60 is connected to the connector 42 of the first housing 34, the drive control portion 41 is electrically connected to the ECU 50.

When the connector 62 of the wire harness 60 is connected to the connector 42 of the first housing 34, while the connector 63 of the wire harness 60 is connected to the connector 43 of the second housing 35, then the drive control portion 41 is electrically connected to the third electric motor 33a and to the third position sensor 33g.

As above, the drive control portion 41 is electrically connected to not only the ECU 50 but the third electric motor 33a as well as the third position sensor 33g of the third actuator 33, by means of the single connector 42 of the first housing 34.

An operation of the first to third actuators 31, 32 and 33 will be explained below.

During an automatic control operation of the air conditioning apparatus, the ECU 50 decides target positions for the air mode switching doors 16, 17 and 18, the air mixing door 11 and the intake air switching door 5, in accordance with a set temperature and information for heat load of the air conditioning apparatus inputted from various sensors. Then the ECU 50 outputs control signals so that each of the air control doors may be moved to the respective target positions.

Then, the drive control portion 41 controls driving powers to be supplied to the respective first to third electric motors 31a, 32a and 33a, in accordance with the control signals inputted to the drive control portion 41 from the ECU 50. The first to third electric motors 31a, 32a and 33a are operated so that each of the air mode switching doors 16, 17 and 18, the air mixing door 11 and the intake air switching door 5 may be moved to their respective target positions.

The drive control portion 41 also outputs the detection signals of the first to third position sensors 31g, 32g and 33g. The ECU 50 carries out feed-back control based on the detection signals of the first to third position sensors 31g, 32g and 33g, so that the ECU 50 outputs a further control signal for correcting the position of the air control doors, if any one of the door positions is not at the target position.

Characterizing features of the present embodiment will be explained.

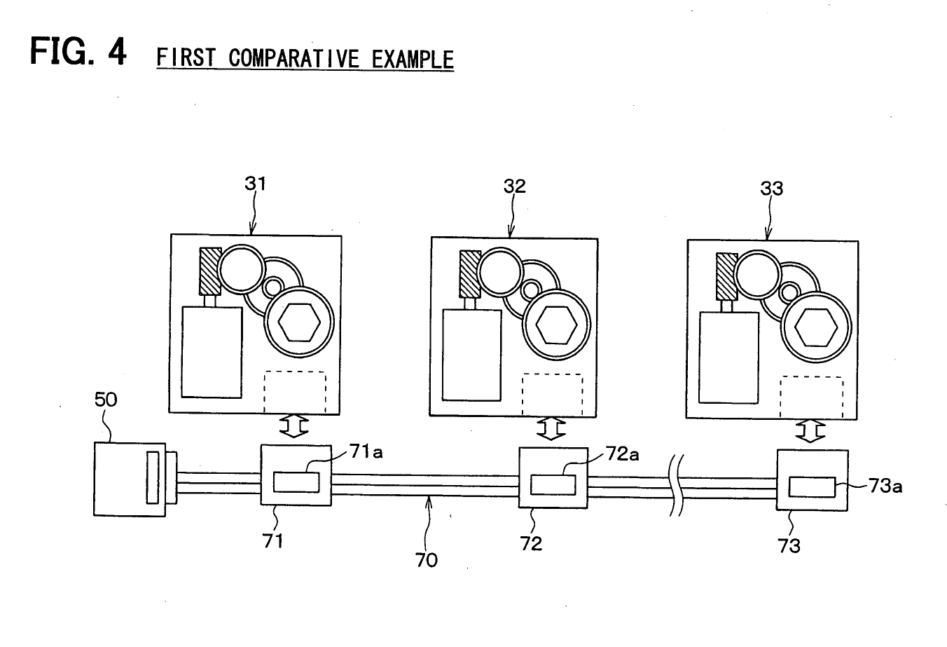

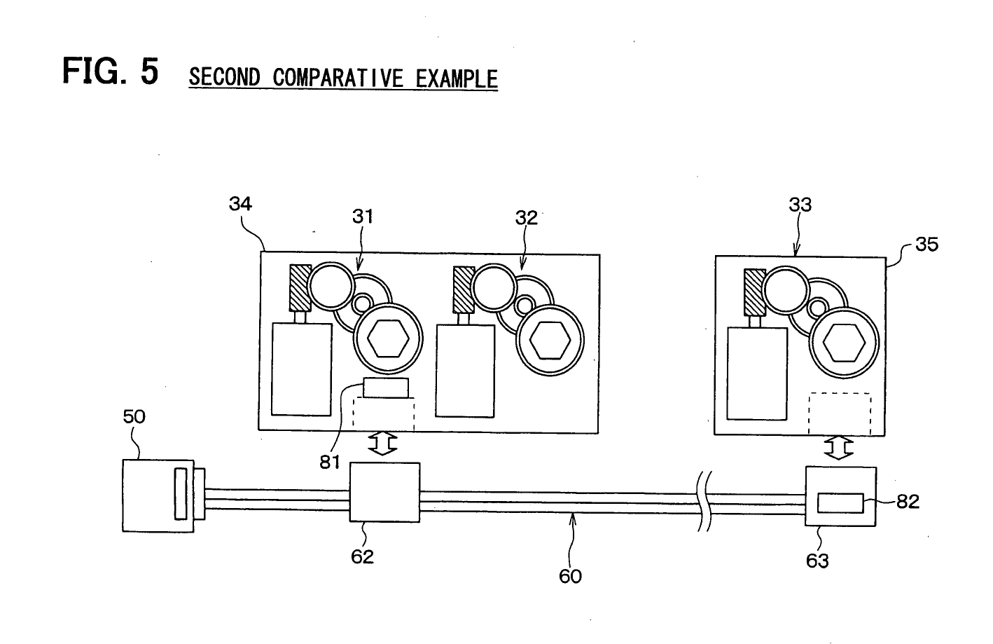

Schematic structures of the respective actuators for first and second comparative examples are shown in FIGS. 4 and 5.

According to the first comparative example shown in FIG. 4, each of the actuators 31, 32 and 33 is accommodated in respective housings. Namely, the first to the third actuators are not modularized in the first comparative example. Drive control portions 71a, 72a and 73a, which are connected to the respective actuators 31, 32 and 33, are respectively incorporated in each of connectors 71, 72 and 73 of a wire harness 70.

According to the second comparative example shown in FIG. 5, a first drive control portion 81 (for the first and second actuators 31 and 32) is provided in the first housing 34, while another (a second) drive control portion 82 (for the third actuator 33) which is different from the first drive control portion 81 is provided in the connector 63 of the wire harness 60, wherein the connector 63 is connected to the second housing 35. Therefore, independent IC chips, namely one IC chip for driving circuits for the first and second actuators 31 and 32 and the other IC chip for a drive circuit for the third actuator 33, are necessary. The other structures for the first to third actuators are the same to those of the first embodiment (FIG. 3).

According, to the present embodiment (FIG. 3), the first and second actuators 31 and 32 are accommodated in the common first housing 34. Therefore, when compared with the first comparative example (FIG. 4), it is possible according to the present embodiment to reduce a number of connectors, to reduce housing material as a result of reducing a total area for the housings, and to reduce a number of assembling processes for assembling the housings to the casing of the air conditioning apparatus. As a result, the cost-down of the actuators for operating the air control doors, of the air conditioning apparatus can be achieved.

Furthermore, according to the present embodiment, the driving circuits for the first and second actuators 31 and 32 which are modularized and the driving circuit for the third actuator 33 which is not modularized are formed in one IC chip. Therefore, when compared with the second comparative example (FIG. 5), it is possible according to the present embodiment to reduce a manufacturing cost for the drive control portions. This is because, when comparing the cases, in one of which (first case) multiple electronic circuits are formed in one IC chip and in the other of which (second case) the multiple electronic circuits are formed in multiple IC chips, the manufacturing cost of the first case is generally lower than that of the second case.

The present embodiment has the following advantages.

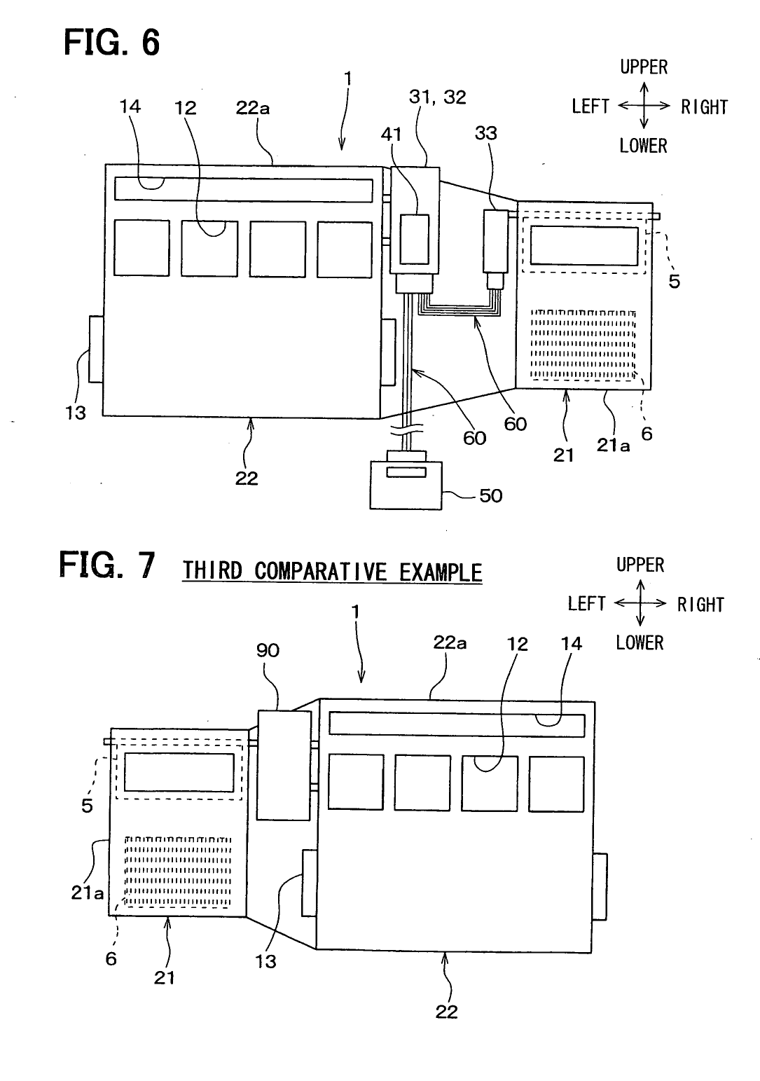

An outline of the A/C inside unit according to the present embodiment is also shown in FIG. 6, wherein the A/C inside unit 1 of FIG. 2 for the right-hand drive vehicle is modified for the left-hand drive vehicle.

According to the A/C inside unit 1 shown in FIG. 6, the blower unit 21 is arranged at a right-hand side of the A/C unit 22 (that is, a right-hand side of the vehicle). An inside structure of the A/C unit 22 for the left-hand drive vehicle is the same to that of the A/C unit 22 shown in FIG. 2 for the right-hand drive vehicle.

In addition, a direction of inserting the components (such as the heater core 8, and so on) into the A/C unit casing 22a during a manufacturing (assembling) process is the same to each other.

As a result that the blower-unit 21 is changed from the left-hand side (FIG. 2) to the right-hand side (FIG. 6) of the A/C unit 22, a location of the third actuator 33 for the intake air switching door 5 is correspondingly changed from a right-hand side of a blower unit casing 21a (FIG. 2) to a left-hand side of the blower unit casing 21a (FIG. 6).

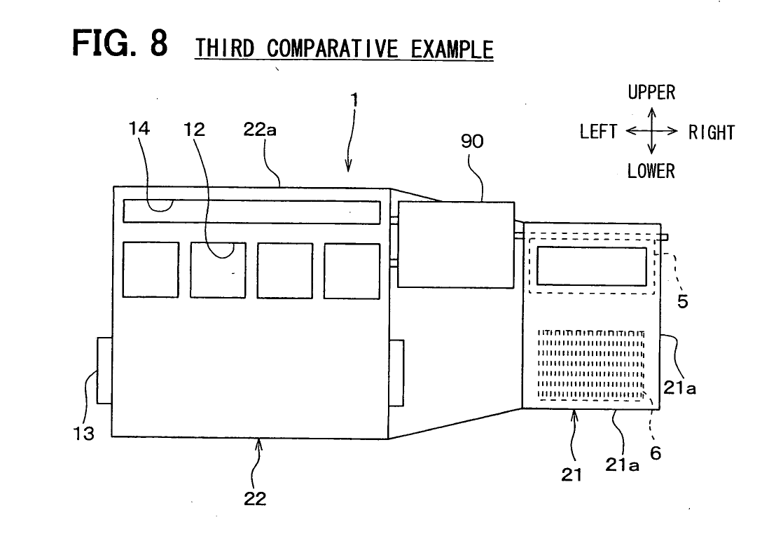

Outlines of the A/C inside units 1 according to a third comparative example are respectively shown in FIGS. 7 and 8, wherein the A/C inside unit 1 of FIG. 7 is for the right-hand drive vehicle, while the A/C inside unit 1 of FIG. 8 is for the left-hand drive vehicle. According to the third comparative example, the first to third actuators 31, 32 and 33 as well as the drive control portion are accommodated in a single housing 90, so that they are modularized.

When the first to third actuators 31, 32 and 33 are modularized as in the third comparative example, coupling portions (link devices) for coupling each of the actuators to the respective air control doors are provided in the same housing 90. As a result, it may be a problem that locations of the components for the A/C unit 22 as well as assembling methods for the components are different from each other, between the A/C unit 22 for the right-hand drive vehicle and the A/C unit 22 for the left-hand drive vehicle.

In other words, it is necessary to arrange the housing 90 between the blower unit 21 and the A/C unit 22, in order to drive not only the intake air switching door 5 provided in the blower unit 21 but the air mode switching doors 16, 17 and 18 as well as the air mixing door 11 provided in the A/C unit 22. Accordingly, it is necessary to locate the housing 90 at the left-hand side of the A/C unit 22 for the right-hand drive vehicle (FIG. 7), while the housing 90 should be located at the right-hand side of the A/C unit 22 for the left-hand drive vehicle (FIG. 8).

As a result of the above different locations of the housing 90, the coupling positions (link devices) of the actuators for the air mode switching doors 16, 17 and 18 as well as the air mixing door 11 are different from each other, between the A/C unit 22 for the right-hand drive vehicle and the A/C unit 22 for the left-hand drive vehicle. Therefore, it is necessary to change the locations of the components in the inside of the A/C unit 22, and/or to change the direction of inserting the components (such as the heater core 8 and so on) into the A/C unit 22 during the assembling process. This means that the A/C units 22 for the right-hand drive and left-hand drive vehicles should be separately manufactured. This may increase the manufacturing cost for the A/C inside unit 1.

According to the embodiment of the present invention, however, the third actuator 33 for the intake air switching door 5 is not modularized but separately provided from the first and second actuators 31 and 32 for the air mode switching doors 16, 17 and 18 as well as the air mixing door 11. It is, therefore, not necessary to locate all of the actuators 31, 32 and 33 between the blower unit 21 and the A/C unit 22. As shown in FIG. 6, even in the case for the left-hand drive vehicle, it is possible to locate the first housing 34 for the first and second actuators 31 and 32 at the right-hand side of the A/C unit 22, as in the same manner to that for the right-hand drive vehicle shown in FIG. 2. This means that the structure as well as the assembling method for the A/C unit can be made in common with each other, between the A/C inside units 1 for the right-hand drive and left-hand drive vehicles. It is, therefore, possible to reduce the cost for manufacturing the A/C inside unit as a result of the common use of the components and/or assembling methods.

In the A/C inside unit 1 shown in FIG. 6, the third actuator 33 may be provided not at the left-hand side but at the right-hand side of the blower unit casing 21a, as in the same manner to that shown in FIG. 2.

### (Modifications)

(1) In the above embodiment, the driving circuits for the first to third electric motors 31a, 32a and 33a are formed in the single IC chip. However, the driving circuits may be formed on the single electronic circuit board. In other words, the driving circuits are formed in respective IC chips, which will be mounted on the single circuit board. Even with such a modification, it is possible to reduce the manufacturing cost for the drive control portions, when compared with a case in which the driving circuits for the first to third electric motors 31a, 32a and 33a are formed on individual circuit boards. Generally, in a case that multiple electronic circuits are put together and formed on a single circuit board, a total area of the circuit board can be decreased and a manufacturing cost can be reduced, when compared with a case in which the multiple electronic circuits are respectively formed on multiple electronic circuit boards. According to the above modification of the invention, the manufacturing cost is reduced based on the above general rule.

(2) In the above embodiment, as shown in FIG. 3, the third actuator 33 is accommodated in the special second housing 35. The third actuator 33 may not be always accommodated in the special housing.

(3) In the above embodiment, the first actuator 31 for the air mode switching doors 16, 17 and 18 and the second actuator 32 for the air mixing door 11 are modularized with each other. Another actuator may be put together to the modularized actuators 31 and 32, or any other combinations of the actuators may be modularized. For example, in a case that there are multiple actuators for the air mode switching doors, those actuators may be put together so as to be modularized.

In the above embodiment, the third actuator 33 for the intake air switching door 5 is not modularized. However, any other actuators may be alternatively selected as such actuator, which would not be modularized. For example, an actuator for an air mode switching door(s) for a rear seat, an actuator for a temperature control door for an air conditioning apparatus in which temperatures for a left-hand passenger room and for a right-hand passenger room are independently controlled, an actuator for one of (left-hand side and right-hand side) air mode switching doors, may be such actuator, which would not be modularized.

(4) In the above embodiment, the components which will be operated by the first to third actuators 31, 32 and 33 are the switching doors, which open and/or close the air passage(s). However, any other components may be operated by the actuators. For example, a flow-amount adjusting valve for controlling flow-amount of hot water flowing into the heater core, an expansion valve of a refrigerating cycle may be such components, which would be operated by the actuators of the present invention.

(5) In the above embodiment, the drive control portion 41 has the function for transmitting (outputting) the detection signals from the first to third position sensors 31g, 32g and 33g to the ECU 50. However, the drive control portion 41 may have such a function for outputting detection signals from various sensors (which are provided for the purpose of obtaining heat loads for the vehicle) to the ECU 50. For example, such sensors may be a temperature sensor for detecting temperature of the air having passed through the evaporator, a temperature sensor for detecting the temperature of the air before flowing into the evaporator, and so on.

(6) In the above embodiment, the A/C inside unit 1 is the semi-center type unit. The present invention may be applied to any other types of the A/C inside units.

### Second Embodiment

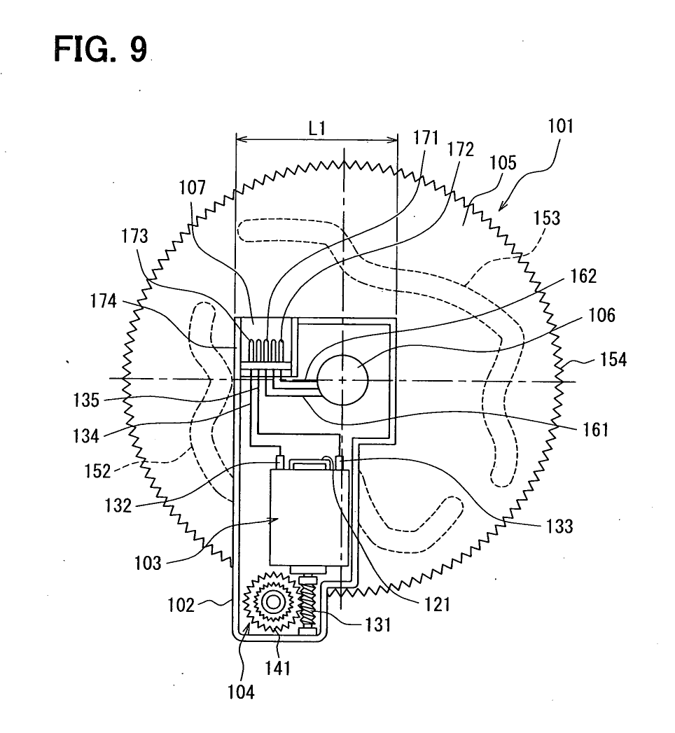

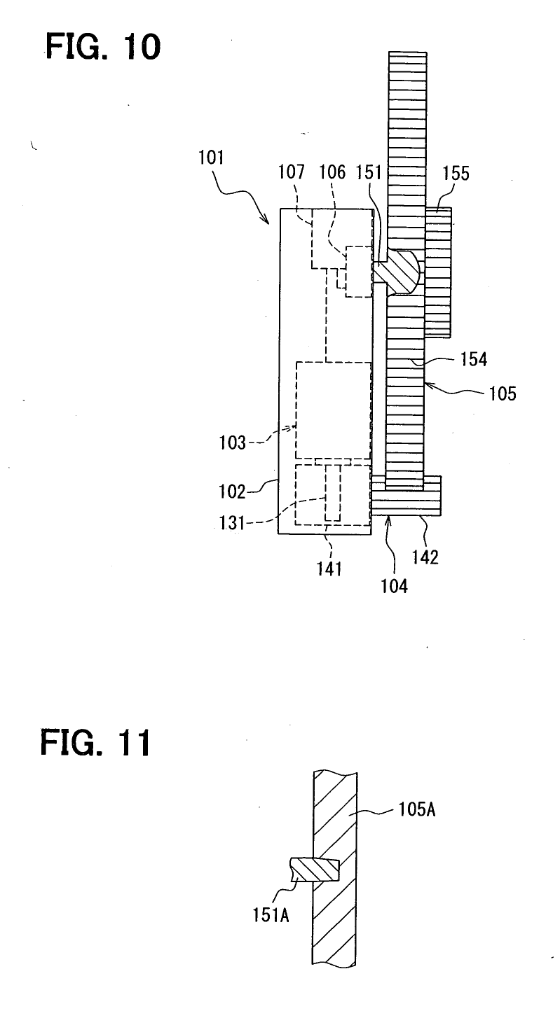

An actuator device 101 will be explained with reference to the drawings. FIG. 9 is a schematic view showing a structure of the actuator device 101 according to a second embodiment of the present invention, wherein a cover portion forming an actuator casing 102 is removed so that an inside structure can be seen. FIG. 10 is a schematic side view (a partly cross sectional view) showing a coupling structure between a second reduction gear 105 and a shaft portion 151 to be connected to a sensor 106.

The actuator device 101 can be widely applied to a device, in which a positioning control (a control for a stopping position) is necessary for a driven unit (or a driven member) which is operated by the actuator device. For example, the actuator device 101 may be composed of a device for driving a link member, which is directly or indirectly linked with various kinds of the air control doors (also referred to as a driven member) of an air conditioning apparatus or an air purifying apparatus for a vehicle, for a home use, for an office use and so on.

More exactly, the actuator device 101 may be used as the actuators 31, 32 and/or 33 of the first embodiment.

The actuator device 101 is composed of; an electric motor 103 for outputting a rotational power for driving the driven member (such as various kinds of air control doors of the air conditioning apparatus); a worm 131; a first reduction gear 104 (that is, a first rotating member 104); a second reduction gear 105 (that is, a second rotating member 105); a sensor 106 for detecting a rotational angle of the second reduction gear 105; and a connector portion 107.

The electric motor 103 is a DC motor having a motor yoke, which is formed in a cylindrical shape having a closed axial end. An output shaft of the electric motor 103 is projected in an axial direction (in a downward direction in FIG. 9) from a center of an end surface, which is perpendicular to the axial direction of the motor yoke. The motor yoke is supported by a motor supporting member 121, which is projected from an inner wall of the actuator casing 102, so that the motor yoke is positioned at a certain position. The worm 131 is provided at the output shaft of the electric motor 103, so that the worm 131 is integrally rotated with the output shaft. The worm 131 is engaged with the first reduction 104. More exactly, the worm 131 is engaged with an input side gear portion 141 of the first reduction gear 104.

The first reduction gear 104 has the input side gear portion 141 which is engaged with the worm 131, and an output side gear portion 142 which is coaxial with the input side gear portion 141 and outwardly projects in an axial direction opposite to the input side gear portion 141. A shaft for the input side and output side gear portions 141 and 142 is rotatably supported by a bearing (not shown) for the first reduction gear 104. A number of gear teeth of the output side gear portion 142 is made to be smaller than that of the input side gear portion 141. The first reduction 104 is engaged with the second reduction 105 via the output side gear portion 142.

The second reduction gear 105 is a gear formed at an outer periphery of a large-diameter disc portion and composed of; an input side gear portion 154 engaged with the output side gear portion 142 of the first reduction gear 104 so that rotational force is transmitted from the first reduction gear 104 to the input side gear portion 154; and an output side gear portion 155 which is coaxial with the input side gear portion 154 and outwardly projects in an axial direction opposite to the input side gear portion 154. The output side gear portion 155 is formed at an outer periphery of a small-diameter disc portion, which is smaller in diameter than the large-diameter disc portion for the input side gear portion 154. The input side gear portion 154 and the output side gear portion 142 of the first reduction gear 104 form a pair of gear mechanism, wherein a number of gear teeth of the input side gear portion 154 is made to be larger than that of the output side gear portion 142. A number of gear teeth of the output side gear portion 155 is made to be smaller than that of the input side gear portion 154. According to the above structure, the rotational speed of the electric motor 103 is reduced to an appropriate speed and the rotational force thus reduced in its speed is transmitted to the driven member, such as the air control doors of the air conditioning apparatus. The shaft portion 151 for the input side and output side gear portions 154 and 155 is rotatably supported by a bearing (not shown) for the second reduction gear 105.

The output side gear portion 155 is a gear portion, which is integrally rotated with the shaft portion 151, and which is engaged with a gear portion (not shown) to be coupled with the driven member (e.g. the air control doors) for transmitting the rotational force of the second reduction gear 105 to the driven member. As indicated by dotted lines in FIG. 9, cam grooves 152 and 153 may be formed on a side surface of the disc portion of the second reduction gear 105 for the input side gear portion 154, which is on a side opposite to the electric motor 103 (on a right-hand side in FIG. 10). The cam grooves 152 and 153 are coupled with a link member (not shown) connected to the driven member. As above, since the driven member (e.g. the air control doors) is directly or indirectly connected to the output side gear portion 155 or the cam grooves 152 and 153, the rotational force generated at the electric motor 103 is transmitted to the worm 131, the first reduction gear 104 and the second reduction gear 105, to drive the driven member. Since the structure for driving the driven member by the second reduction gear 105, such as the output side gear portion 155 or the cam grooves 152 and 153, is directly formed in the second reduction 105, the structure itself is simple, a number of parts and components can be reduced, and thereby the actuator device 101 having a good quality of productivity is realized.

As shown in FIG. 10, the shaft portion 151 is integrally formed with the disc portion of the second reduction gear 105 for the input side gear portion 154 at a center thereof, so that the shaft portion 151 is rotated together with the second reduction gear 105 without displacement between the shaft portion 151 and the second reduction gear 105. The shaft portion 151 projects from the second reduction gear 105 in a direction toward the actuator casing 102.

As shown in FIG. 11, a shaft portion 151A may be alternatively press inserted into a disc portion of a second reduction gear 105A for the input side gear portion 154, so that the shaft portion 151A is firmly fixed to the disc portion. As above, the shaft portion 151 or 151A is integrally rotated with the second reduction gear 105 or 105A.

As shown in FIG. 10, the second reduction gear 105, the shaft portion 151, the output side gear portion 142 of the first reduction gear 104 and so on are arranged at an outside of the actuator casing 102, while the electric motor 103, the worm 131, the input side gear portion 141 of the first reduction gear 104, the sensor 106, the connector portion 107 are accommodated in the actuator casing 102. The actuator casing 102 is composed of multiple casing units, which are made of, for example, resin material such as polypropylene. The multiple casing units are assembled and integrally connected to each other by fixing means, such as metal springs, screws and so on, to form the actuator casing 2.

As shown in FIG. 9, the sensor 106 is accommodated in the same actuator casing 102, in which the electric motor 103, the input side gear portion 141 of the first reduction gear 104 and the connector portion 107 are accommodated. The sensor 106 is connected to the shaft portion 151, which is provided at the center of the disc portion (also referred tows a first disc portion) of the input side gear portion 154 for the second reduction gear 105, so that the sensor 106 is rotated together with the second reduction gear 105. The sensor 106 has, for example, an insertion hole (not shown) into which a part of the shaft portion 151 is inserted and fixed to the sensor 106, so that the sensor 106 and the shaft portion 151 are rotated together. The sensor 106 is composed of, for example, a potentiometer having a variable resister in an inside thereof, a rotary encoder of a digital type sensor, to detect a rotational angle of the second reduction gear 105.

The sensor 106 is arranged on a center axis of the first disc portion (154). The connector portion 107 is arranged at a side of the sensor 106 in a radial direction. The input side gear portion 141 of the first reduction gear 104 is arranged at an outer periphery of the first disc portion. The input side gear portion 141 is located at a position, which is on a line perpendicular to a direction of the connector portion 107 with respect to the sensor 106. The electric motor 103 is located between the input side gear portion 141 of the first reduction gear 104 and the sensor 106. The electric motor 103 has power supply terminals 132 and 133, one of which is directed toward the sensor 106 (toward the center axis line of the first disc portion) and the other of which is directed toward the connector portion 107.

As shown in FIG. 10, a length (a height), of the actuator casing 102 in the axial direction of the second reduction gear 105 is made as smaller as possible, by taking a size (an outer diameter) of the electric motor 103 into consideration. The sensor 106, the connector portion 107 and the input side gear portion 141 of the first reduction gear 104 are, as a matter of course, designed and/or arranged in the actuator casing 102 in such a manner that a size and/or position thereof is smaller than the length (the height) of the actuator casing 102.

The connector portion 107 has wires 134, 135, 161 and 162 for supplying electric power to the electric motor 103 and the sensor 106 and for receiving detected signal from the sensor 106. The connector portion 107 has multiple connector pins 171, 172 and 173 and a connector housing 174. The connector housing 174 is made of resin material and supports the connector pins 171 to 173. The housing 174 has an opening portion, which is opened in a direction in parallel to a side surface of the first disc portion of the second reduction gear 105 (that is, an upward direction in FIGS. 9 and 10), and into which an outside connector (not shown) will be inserted. The connector pins (five pins) 171 to 173 project into the opening portion in the upward direction. The outside connector is inserted into the opening portion in the direction, which is in parallel to the side surface of the first disc portion of the second reduction gear 105, so that the connector pins 171 to 173 are electrically connected to the outside connector.

The connector pins 171 are connected to power supply terminals of the sensor 106 via the wires 161, while the connector pin 172 is connected to an output portion of the sensor 106 for the detected signal via the wire 162. The connector pins 173 are respectively connected to the power supply terminals 132 and 133 of the electric motor 103 via the wires 134 and 135.

Advantages of the actuator device 101 according to the second embodiment will be explained.

If the shaft portion (the rotational angle thereof is detected) and the rotational meinber (that is the subject for the detection of the rotational angle) are connected to each other by a simple fit-in structure, the rotational displacement may occur between them due to fit tolerance (dimensional tolerance). Therefore, in such a case, even when the rotational angle of the shaft portion is accurately detected, the rotational angle of the rotational member can not be accurately detected.

According to the actuator device 101 of the second embodiment, the first and second reduction gears 104 and 105 are engaged with each other, the rotational force of the electric motor 103 is transmitted to the reduction gear is reduced in its rotational speed, and the rotational angle of the second reduction gear 105 is detected by the sensor 106. The second reduction gear 105 has the shaft portion 151, which is rotated together with the second reduction gear 105 without generating the rotational displacement between them. The sensor 106 is accommodated in the actuator casing 102, in which the electric motor 103 is also accommodated; and connected to the shaft portion 151 so that the sensor 106 is rotated together with the shaft portion 151.

According to the above structure, the shaft portion 151 is rotated together with the second reduction gear 105 without causing the rotational displacement between them, so that the rotational angle of the second reduction gear 105 is identical to that of the shaft portion 151. Namely, the detected rotational angle of the shaft portion 151 detected by the sensor 106 exactly coincides with the rotational angle of the second reduction gear 105. Accordingly, the actuator device 101 is realized, according to which the accurate detection of the rotating member (the second reduction gear 105) is possible, in addition that the number of the gears can be reduced.

Furthermore, according to the present embodiment, the sensor 106 is accommodated in the actuator casing 102, in which the electric motor 103 is also accommodated. Therefore, the sensor 106 and the electric motor 103 can be arranged at such positions close to each other, that a complicated structure for the wires for the power supply and the transmittance of the detected signals can be avoided. As a result, the structure in the inside of the actuator casing 102 can be made simpler. It is, therefore, possible to reduce the cost for the parts and components (such as, the wires), to reduce the manufacturing cost, and to reduce the size of the actuator casing 102.

The electric motor 103 is arranged in the actuator casing 102 between the sensor 106 and the input side gear portion 141 of the first reduction gear 104, which is engaged with the input side gear portion 154 of the second reduction gear 105. The output side gear portion 142 of the first reduction gear 104 is engaged with the input side gear portion 154 of the second reduction gear 105, wherein the input side gear portion 154 is formed at the outer periphery of the disc portion. Therefore, there is a certain distance between the first reduction gear 104 and the sensor 106 which is located at the rotational axis of the second reduction gear 105. The distance almost corresponds to a radius of the input side gear portion 154 of the second reduction gear 105.

The electric motor 103 is arranged in the actuator casing 102 between the first reduction gear 104 and the sensor 106 on the axial side of the second reduction gear 105. The electric motor 103 is arranged in such a space of the actuator casing 102, wherein the space is formed within the distance (the radius of the input side gear portion 154). The inside space of the actuator casing 102 is, therefore, effectively used. The parts and components are located in the actuator casing 102 in such a manner to effectively use the length of the radius of the second reduction gear 105. In addition, the length of the actuator casing 102 in the axial direction of the second reduction gear 105 can be smaller.

The power supply terminals 132 and 133 of the electric motor 103 are provided on the side of the sensor 106. According to such a structure, the connector portion 107 can be located in the actuator casing 102 at such a position, that length of the wires for the power supply to the electric motor 103, the wires for the power supply to the sensor 106 as well as the wire for the detected signals from the sensor 106 may be made shorter. As a result, the size of the actuator casing 102 can be made smaller.

The sensor 106 and the connector portion 107 are arranged in the actuator casing 102 at portions close to each other. In other words, the connector portion 107 is arranged at the portion close to the axial line of the second reduction gear 105. As a result, the length of the actuator casing 102, that is a width L1 shown in FIG. 9, can be made smaller, to thereby reduce volume of the inside space of the actuator casing 102. A space necessary for mounting the actuator device 101 can be accordingly reduced.

### Third Embodiment

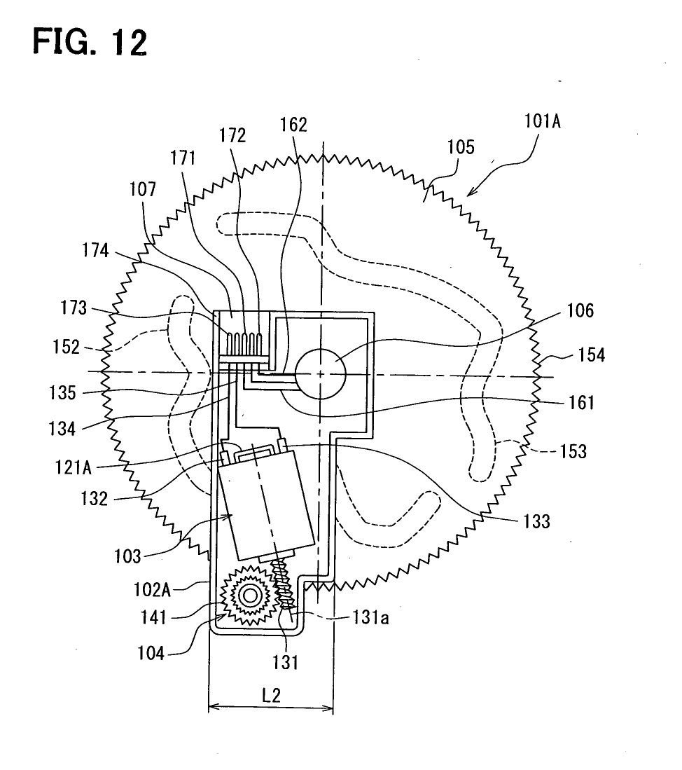

An actuator device 101A according to a third embodiment, which is different from the second embodiment in locations of the parts and components, will be explained with reference to FIG. 12. FIG. 12 is a schematic view showing a structure of the actuator device 101A.

As shown in FIG. 12, the electric motor 103 is accommodated in an actuator casing 102A in such a manner that a rotational shaft 131a of the electric motor 103 is inclined. More exactly, the electric motor 103 is inclined with respect to a side wall of the actuator casing 102A, so that the power supply terminals 132 and 133 are arranged at positions closer to the connector portion 107 than the sensor 106. In other words, an end surface of a motor housing, on which the power supply terminals 132 and 133 are provided, is directed toward not the sensor 106 but the connector portion 107. The power supply terminals 132 and 133 can be arranged at portions closer to the connector portion 107, when compared with the second embodiment. The motor housing is supported in the actuator casing 102A by a motor supporting member 121A.

According to the above structure, an engaging portion between the worm 131 and the input side gear portion 141 of the first reduction gear 104 becomes closer to the rotational axial line of the second reduction gear 105, and a width (a length L2 in FIG. 12) of the actuator casing 102A can be made smaller than that of the second embodiment. Therefore, a space necessary for mounting the actuator device 101A can be further reduced.

### (Modifications)

The present invention should not be limited to the above embodiments, but various kinds of modifications may be possible without departing from the spirit of the invention.

According to the above second or third embodiment, one driving unit, which is composed of the electric motor 103, the sensor 106, the reduction gears 104, 105 and the connector portion 107, is accommodated in the actuator casing and drives one air control door of the air conditioning apparatus. However, multiple driving units for respectively driving multiple air control doors of the air conditioning apparatus may be accommodated in the actuator casing. For example, the driving units for respectively driving the air mode switching doors, the air mixing door and the intake air switching door may be accommodated in one actuator casing.

According to the present embodiments, the number of reduction gears is decreased, while the disc portion of the second reduction gear 105 is made larger in order to obtain a desired reduction ratio. And the space at the side surface of the second reduction gear is effectively used as the space for the parts and components of the actuator device. As a result, the size of the actuator device can be made smaller, even if the size of the second reduction gear is made larger.

What is claimed is:

1. A driving apparatus for an air conditioning system comprising:
a first electrical actuator for controlling a first air control member and a second electrical actuator for controlling a second air control member, both of which are accommodated in a housing;
a third electrical actuator for controlling a third air control member and provided at a location separated from the housing; and
a drive control portion for electrically controlling operations of the first to third electrical actuators,
wherein the drive control portion is accommodated in the housing and driving circuits of the drive control portion for the respective electrical actuators are formed in a single IC chip or formed on a single electrical circuit board.

2. The driving apparatus for the air conditioning system according to the claim 1, further comprising:
a connector provided in the housing and electrically connected to the drive control portion, wherein the third electrical actuator is electrically connected to the drive control portion via the connector; and
an electronic control unit for outputting a control signal to the drive control portion, wherein the electronic control unit is electrically connected to the drive control portion.

3. The driving apparatus for the air conditioning system according to the claim 1, wherein
the driving apparatus is applied to an air conditioning apparatus for a vehicle,
the first electrical actuator drives the first air control member, which is composed of air mode switching doors for switching an air blowing duct from which air is blown into a passenger compartment of the vehicle,
the second electrical actuator drives the second air control member, which is composed of an air mixing door for controlling temperature of the air to be blown into the passenger compartment, and
the third electrical actuator drives the third air control member, which is composed of an intake air switching door for switching from outside air to inside air and vice versa.

4. An air conditioning system for a vehicle comprising:
a blower unit having a blower device for blowing air into a passenger, compartment of the vehicle;
an intake air switching door provided in the blower unit for switching the blowing air from outside air to inside air and vice versa;
an A/C unit having an evaporator for cooling down the blowing air and a heater core for heating the blowing air;
an air mixing door provided in the A/C unit for controlling temperature of the blowing air to be blown into the passenger compartment;
air mode switching doors provided in the A/C unit for switching an air blowing duct from which the blowing air is blown into the passenger compartment;
a first electrical actuator for driving the air mode switching doors;
a second electrical actuator for driving the air mixing door; and
a third electrical actuator for driving the intake air switching door,
wherein the blower unit and the A/C unit are mounted in the vehicle in such a manner that the blower unit is arranged at a left-hand side or a right-hand side of the A/C unit with respect to a longitudinal direction of the vehicle,
wherein the first and second electrical actuators, are accommodated in a housing, which is attached to the A/C unit
wherein the third electrical actuator is attached to the blower unit,
wherein a drive control portion for electrically controlling operations of the first to third electrical actuators is further provided; and
wherein the drive control portion is accommodated in the housing and driving circuits of the drive control portion for the respective electrical actuators are formed in a single IC chip or formed on a single electrical circuit board.

5. The driving apparatus for the air conditioning system according to the claim 1, wherein at least one of the first to third electrical, actuators comprises;
an actuator casing;
an electric motor accommodated in the actuator casing;
a first rotational member connected to the electric motor for outputting a rotational force of the electric motor;
a second rotational member to be connected to an air control member, the second rotational member being engaged with the first rotational member so that the rotational force is reduced in speed;
a sensor for detecting a rotational position of the second rotational member;
a shaft portion provided at the second rotational member so that the shaft portion is integrally rotated with the second rotational member without any rotational displacement between the shaft portion and the second rotational member,
wherein the sensor is accommodated in the actuator casing and connected to the shaft portion so that the sensor is rotated together with the shaft portion.

6. The air conditioning system according to the claim 4, wherein
at least one of the first to third electrical actuators comprises;
an actuator casing;
an electric motor accommodated in the actuator casing;
a first rotational member connected to the electric motor for outputting a rotational force of the electric motor;
a second rotational member to be connected to an air control member, the second rotational member being engaged with the first rotational member so that the rotational force is reduced in speed;
a sensor for detecting a rotational position of the second rotational member;
a shaft portion provided at the second rotational member so that the shaft portion is integrally rotated with the second rotational member without any rotational displacement between the shaft portion and the second rotational member,
wherein the sensor is accommodated in the actuator casing and connected to the shaft portion so that the sensor is rotated together with the shaft portion.

7. An actuator device comprising:
an actuator casing;
an electric motor accommodated in the actuator casing;
a first rotational member connected to the electric motor for outputting a rotational force of the electric motor;
a second rotational member to be connected to a driven member, the second rotational member being engaged with the first rotational member so that the rotational force is reduced in speed;
a sensor for detecting a rotational position of the second rotational member;
a shaft portion provided at the second rotational member so that the shaft portion is integrally rotated with the second rotational member without any rotational displacement between the shaft portion and the second rotational member,
wherein the sensor is accommodated in the actuator casing and connected to the shaft portion so that the sensor is rotated together with the shaft portion.

8. The actuator device according to the claim 7, wherein
the electric motor is arranged at a side portion of the second rotational member in an axial direction of the second rotational member, and located between the sensor and the first rotational member which is engaged with the second rotational member at an outer periphery of the second rotational member.

9. The actuator device according to the claim 8, wherein
the electric motor has power supply terminals, and
the electric motor is accommodated in the actuator casing in such a manner that the power supply terminals are located on a side of the electric motor close to the sensor.

10. The actuator device according to the claim 9, further comprising:
first wires for supplying electric power to the electric motor;
second wires for supplying the electric power to the sensor and for receiving detected signals from the sensor; and
a connector portion connected to the first and second wires, wherein the first and second wires and the connector portion are accommodated in the actuator casing, and
the electric motor is arranged at such a position in the actuator casing, that the power supply terminals are located at a portion which is closer to the connector portion than to the sensor.

11. The actuator device according to the claim 7, wherein
the first rotational member and the second rotational member form a pair of reduction gear engaged with each other.

12. The actuator device according to the claim 7, further comprising:
the second rotational member has an output side gear portion or cam grooves for driving the driven member, wherein the output side gear portion or the cam grooves are rotated together with the shaft portion.
